(19) United States
(12) Patent Application Publication
(10) Pub. No.: US 2024/0324065 A1
(43) Pub. Date: Sep. 26, 2024

(54) METHOD AND APPARATUS FOR RUNNING DRX TIMER, AND TERMINAL DEVICE

(71) Applicant: GUANGDONG OPPO MOBILE TELECOMMUNICATIONS CORP., LTD., Dongguan (CN)

(72) Inventor: Shukun WANG, Dongguan (CN)

(21) Appl. No.: 18/680,274

(22) Filed: May 31, 2024

Related U.S. Application Data
(63) Continuation of application No. PCT/CN2021/135046, filed on Dec. 2, 2021.

(51) Int. Cl. H04W 76/28; H04L 5/00; H04W 76/40

(52) U.S. Cl. CPC H04W 76/28; H04L 5/0053; H04W 76/40

(57) ABSTRACT

Provided in the embodiments of the present application are a method and apparatus for running a DRX timer, and a terminal device. The method includes that: a terminal device starts a first RTT timer at a first moment, wherein the first RTT timer is an RTT timer for an MBS multicast service; and if the first RTT timer times out, the terminal device starts a first retransmission timer, wherein the first retransmission timer is a retransmission timer for the MBS multicast service.

### CROSS-REFERENCE TO RELATED APPLICATION

This is a continuation application of International Patent Application No. PCT/CN2021/135046, filed on Dec. 2, 2021, entitled “METHOD AND APPARATUS FOR RUNNING DRX TIMER, AND TERMINAL DEVICE”, the disclosure of which is hereby incorporated by reference in its entirety.

### BACKGROUND

In a New Radio (NR) system, it needs to support service requirements of multicast type and broadcast type in many scenarios, such as an Internet of Vehicles and an Industrial Internet, etc. Therefore, it is necessary to introduce a Multimedia Broadcast Service (MBS) of multicast type and an MBS of broadcast type into NR.

For the MBS of multicast type (abbreviated as multicast MBS), a DRX mechanism is introduced to save energy for a terminal device. For convenience, DRX used for multicast MBS reception is called MBS DRX, and DRX used for traditional unicast service reception is called unicast DRX. MBS DRX and unicast DRX are independent of each other. Since unicast DRX is oriented to one terminal device, while MBS DRX is oriented to multiple terminal devices, a running mechanism of MBS DRX cannot be the same as that of unicast DRX. How to design the running mechanism of MBS DRX to ensure that multiple terminal devices do not lose packets in the process of receiving multicast MBS is a problem that needs to be clarified.

### SUMMARY

Embodiments of the present disclosure relate to the technical field of mobile communication, and in particular, to a method and an apparatus for running a discontinuous reception (DRX) timer, and a terminal device. In embodiments of the present disclosure, there is provided a method and an apparatus for running a discontinuous reception (DRX) timer, a terminal device, a chip, a computer readable storage medium, a computer program product and a computer program.

A method for running a DRX timer provided by the embodiments of the present disclosure includes the following operations.

A terminal device starts a first round trip time (RTT) timer at a first time, herein the first RTT timer is an RTT timer used for a multicast MBS.

When the first RTT timer expires, the terminal device starts a first retransmission timer, herein the first retransmission timer is a retransmission timer used for the multicast MIBS.

A terminal device provided by the embodiments of the present disclosure includes a processor and a memory. The memory is configured to store a computer program, and the processor is configured to call and execute the computer program stored in the memory to cause the terminal device to perform the method of: starting a first round trip time (RTT) timer at a first time, wherein the first RTT timer is an RTT timer used for a multicast multimedia broadcast service (IBS); and when the first RTT timer expires, starting a first retransmission timer, wherein the first retransmission timer is a retransmission timer used for the multicast IBS.

A chip provided by the embodiments of the present disclosure includes a processor, which is configured to call and execute a computer program from a memory to cause a terminal device equipped with the chip to perform the method of: starting a first round trip time (RTT) timer at a first time, wherein the first RTT timer is an RTT timer used for a multicast multimedia broadcast service (MIBS); and when the first RTT timer expires, starting a first retransmission timer, wherein the first retransmission timer is a retransmission timer used for the multicast IBS.

### BRIEF DESCRIPTION OF THE DRAWINGS

The accompanying drawings illustrated herein are used to provide further understanding of the present disclosure and constitute a part of the present disclosure, and illustrative embodiments of the present disclosure and their description are used to explain the present disclosure, but do not constitute improper limitation to the present disclosure. In the accompanying drawings:

FIG. 1 is a schematic diagram of an application scenario according to an embodiment of the present disclosure.

FIG. 2 is a schematic diagram of a protocol stack corresponding to a PTM manner and a PTP manner according to an embodiment of the present disclosure.

FIG. 3 is a schematic flowchart of a method for running a DRX timer provided by an embodiment of the present disclosure.

FIG. 4 is a schematic diagram of a structural composition of an apparatus for running a DRX timer provided by an embodiment of the present disclosure.

FIG. 5 is a schematic structural diagram of a communication device provided by an embodiment of the present disclosure.

FIG. 6 is a schematic structural diagram of a chip according to an embodiment of the present disclosure.

FIG. 7 is a schematic block diagram of a communication system provided by an embodiment of the present disclosure.

### DETAILED DESCRIPTION

The technical solution of the embodiments of the present disclosure will be described below in conjunction with the drawings in the embodiments of the present disclosure, and it will be apparent that the described embodiments are part of the embodiments of the present disclosure, but not all of them. Based on the embodiments in the present disclosure, all other embodiments obtained by those of ordinary skill in the art without creative work fall within the scope of protection of the present disclosure.

FIG. 1 is a schematic diagram of an application scenario according to an embodiment of the present disclosure.

As illustrated in FIG. 1, the communication system 100 may include terminal devices 110 and a network device 120. The network device 120 may communicate with the terminal device 110 through an air interface. Multi-service transmission is supported between the terminal devices 110 and the network device 120.

It should be understood that embodiments of the present disclosure are illustrative only with the communication system 100 but are not limited thereto. That is, the technical solution of the embodiments of the present disclosure may be applied to various communication systems, such as: a Long Term Evolution (LTE) system, an LTE Time Division Duplex (TDD), a Universal Mobile Telecommunications System (UMTS), an Internet of Things (IoT) system, a Narrow Band Internet of Things (NB-IoT) system, an enhanced Machine-Type Communications (eMTC) system, a 5G communication system (also called a NR communication system), or a future communication system, etc.

In the communication system 100 illustrated in FIG. 1, the network device 120 may be an access network device that communicates with the terminal devices 110. The access network device may provide communication coverage for a particular geographic area and may communicate with the terminal devices 110 (e.g. UE) located within the coverage area.

The network device 120 may be an Evolutional Node B (eNB or eNodeB) in a Long Term Evolution (LTE) system, or a gNB in a Next Generation Radio Access Network (NG RAN) device or an NR system, or a wireless controller in a Cloud Radio Access Network (CRAN), or the network device 120 may be a relay station, an access point, an in-vehicle device, a wearable device, a hub, a switch, a bridge, a router, or a network device in a future evolved Public Land Mobile Network (PLMN), etc.

A terminal device 110 may be any terminal device including but not limited to a terminal device in wired or wireless connection with the network device 120 or other terminal devices.

For example, the terminal device 110 may refer to an access terminal, User Equipment (UE), a subscriber unit, a subscriber station, a mobile station, a mobile platform, a remote station, a remote terminal, a mobile device, a user terminal, a terminal, a wireless communication device, a user agent, or a user device. The access terminal may be a cellular phone, a cordless phone, a session initiation protocol (SIP) telephone, an IoT device, a satellite handheld terminal, a wireless local loop (WLL) station, a personal digital assistant (PDA), a handheld device with wireless communication function, a computing device or other processing device connected to a wireless modem, an in-vehicle device, a wearable device, a terminal device in the 5G network or a terminal device in the future evolved network, etc.

The terminal device 110 may be used for Device to Device (D2D) communication.

The wireless communication system 100 may also include a core network device 130 that communicates with the base station. The core network device 130 may be a 5G Core (5GC) device, for example, an Access and Mobility Management Function (AMF), for another example, an Authentication Server Function (AUSF), for another example, a User Plane Function (UPF), and for another example, a Session Management Function (SMF). Optionally, the core network device 130 may also be an Evolved Packet Core (EPC) device of the LTE network, for example, a Session Management Function+Core Packet Gateway (SMF+PGW-C) device. It should be understood that SMF+PGW-C may achieve the same functions as SMF and PGW-C simultaneously. In the process of network evolution, the core network device may also be called by other names, or a new network entity may be formed by dividing the functions of the core network, which is not limited by the embodiments of the present disclosure.

Each functional unit in the communication system 100 may also establish a connection through a next generation (NG) interface to realize communication.

For example, the terminal device establishes an air interface connection with the access network device through an NR interface for transmitting user plane data and control plane signaling. The terminal device may establish a control plane signaling connection with an AMF through NG interface 1 (abbreviated as N1). The access network device such as a next generation radio access base station (gNB) may establish a user plane data connection with a UPF through NG interface 3 (abbreviated as N3). The access network device may establish a control plane signaling connection with the AMF through NG interface 2 (abbreviated as N2). The UPF may establish a control plane signaling connection with an SMF through NG interface 4 (abbreviated as N4). The UPF may interact user plane data with a data network through NG interface 6 (abbreviated as N6). The AMF may establish a control plane signaling connection with the SMF through NG interface 11 (abbreviated as N11). The SMF may establish a control plane signaling connection with a PCF through NG interface 7 (abbreviated as N7).

FIG. 1 exemplarily illustrates one base station, one core network device and two terminal devices. Optionally, the wireless communication system 100 may include multiple base stations and other numbers of terminal devices may be included within the coverage of each base station, which is not limited by embodiments of the present disclosure.

It should be noted that FIG. 1 is only illustrative of the system to which the present disclosure applies, and of course, the method illustrated in the embodiments of the present disclosure may also be applied to other systems. In addition, the terms “system” and “network” of the present disclosure are often used interchangeably herein. In the present disclosure, the term “and/or” is used to describe an association relationship of associated objects, and represents that there may be three relationships. For example, A and/or B may represent the following three situations: i.e., independent existence of A, existence of both A and B and independent existence of B. In addition, the character “/” in the present disclosure generally represents that an “or” relationship is formed between the previous and next associated objects. It should be understood that the reference to “indicate” in embodiments of the present disclosure may be a direct indication, may be an indirect indication, or may indicate an association relationship. For example, A indicates B, which may mean that A directly indicates B, for example, B may be obtained through A. It may also mean that A indirectly indicates B, for example, A indicates C, and B may be obtained by C. It may also indicate that there is an association relationship between A and B. It should be understood that “correspond” in the description of embodiments of the present disclosure may mean that there is a direct correspondence or an indirect correspondence relationship between the two, may also mean that there is an association relationship between the two, may also be a relationship between indication and being indicated, configuration and being configured, etc. It should also be understood that the “predefined” or “predefined rules” referred to in embodiments of the present disclosure may be implemented by pre-storing corresponding codes, tables, or other manners that may be used to indicate relevant information in devices (e.g., including terminal devices and network devices), the specific implementation of which is not limited by the present disclosure. For example, predefined may refer to what is defined in the protocol. It should also be understood that, in embodiments of the present disclosure, the “protocol” may refer to standard protocols in the communication field, such as LTE protocol, NR protocol, and related protocols applied in future communication systems, which are not limited herein.

In order to facilitate understanding of the technical solution of the embodiments of the present disclosure, the following related technologies of the embodiments of the present disclosure are described, and the following related technologies may be arbitrarily combined with the technical solution of the embodiments of the present disclosure as an optional solution, all of which belong to the protection scope of the embodiments of the present disclosure.

With people's pursuit of speed, latency, high-speed mobility, energy efficiency as well as the diversity and complexity of service in a future life, 3^{rd} generation partnership project (3GPP) international standards organization began to develop 5G. The main application scenarios of 5G include: enhanced mobile broadband (eMBB), ultra-reliable low-latency communications (URLLC) and massive machine-type communications (mMTC).

On the one hand, eMBB still aims at acquisition of multimedia content, services and data for users, and its demand is growing rapidly. On the other hand, eMBB may be deployed in different scenarios, such as indoor, urban, rural, whose capabilities and requirements are quite different, and thus it cannot be generalized and must be analyzed in detail in combination with specific deployment scenarios. Typical applications of URLLC include: industrial automation, power automation, telemedicine operation (such as surgery), traffic safety guarantee and so on. The typical characteristics of mMTC include: high connection density, small data volume, delay-insensitive services, low cost of modules and long service life, etc.

### Multimedia Broadcast Multicast Service (MBMS)

MBMS is a technology that transmits data from one data source to multiple terminal devices by sharing network resources. MBMS can utilize network resources effectively while providing multimedia services, and realize broadcast and multicast of the multimedia services at a higher speed (such as 256 kbps).

Due to the lower spectrum efficiency of the MBMS, it is not enough to carry and support the operation of mobile and TV services effectively. Therefore, in the LTE, 3GPP proposes explicitly to enhance a support capability for downlink high-speed MBMS services, and determines design requirements for a physical layer and an air interface.

3GPP R9 introduces an evolved MBMS (eMBMS) into the LTE. The eMBMS puts forward a concept of Single Frequency Network (SFN), that is, Multimedia Broadcast multicast service Single Frequency Network (MBSFN). MBSFN uses a unified frequency to send service data in all cells at the same time, but it must ensure the synchronization among cells. This manner can improve the overall signal-to-noise ratio distribution of the cell greatly, and the spectrum efficiency will be greatly improved accordingly. The eMBMS implements broadcast and multicast of services based on an IP multicast protocol.

In the LTE or LTE-Advanced (LTE-A), the MBMS has only broadcast bearer mode, without multicast bearer mode. In addition, the reception of MBMS service is suitable for a terminal device in an idle state or a connected state.

The concept of Single Cell Point to Multipoint (SC-PTM) is introduced in 3GPP R13. The SC-PTM is based on the MBMS network architecture.

For the MBMS, it is introduced new logical channels, including a Single Cell-Multicast Control Channel (SC-MCCH) and a Single Cell-Multicast Transport Channel (SC-MTCH). The SC-MCCH and SC-MTCH are mapped onto a Downlink-Shared Channel (DL-SCH), and further, the DL-SCH is mapped onto a Physical Downlink Shared Channel (PDSCH), where SC-MCCH and SC-MTCH are logical channels, the DL-SCH is a transport channel, and the PDSCH is a physical channel. The SC-MCCH and SC-MTCH do not support Hybrid Automatic Repeat reQuest (HARQ) operations.

For the MBMS, it is introduced a new System Information Block (SIB) type, i.e., SIB20. Specifically, configuration information of the SC-MCCH is transmitted through the SIB20 and there is only one SC-MCCH per cell. The configuration information of SC-MCCH includes a modification period of SC-MCCH, a repetition period of SC-MCCH, and a radio frame and subframe of scheduling SC-MCCH. Further, 1) a boundary of the modification period of SC-MCCH satisfies SFN mod m=0, where SFN represents a system frame number of the boundary, and m is the modification period of SC-MCCH configured in SIB20 (i.e. sc-mech-ModificationPeriod). 2) The radio frame for scheduling SC-MCCH satisfies: SFN mod mcch-RepetitionPeriod=mcch-Offset, where SFN represents a system frame number of the radio frame, mcch-RepetitionPeriod represents the repetition period of SC-MCCH, and mcch-Offset represents an offset of SC-MCCH. 3) The subframe for scheduling SC-MCCH is indicated by sc-mcch-Subframe.

The SC-MCCH is scheduled through a Physical Downlink Control Channel (PDCCH). On the one hand, a new Radio Network Temporary Identity (RNTI) is introduced, that is, Single Cell RNTI (SC-RNTI), to identify PDCCH (such as SC-MCCH PDCCH) used to schedule SC-MCCH. Optionally, the SC-RNTI has a fixed value of FFFC. On the other hand, a new RNTI is introduced, that is, Single Cell Notification RNTI (SC-N-RNTI), to identify PDCCH (such as notification PDCCH) used to indicate a change notification of SC-MCCH. Optionally, SC-N-RNTI has a fixed value of FFFB. Further, the change notification may be indicated with one of eight bits of DCI 1C. In the LTE, the configuration information of SC-PTM is based on the SC-MCCH configured by SIB20, and then the SC-MCCH configures the SC-MTCH, which is used to transmit service data.

Specifically, SC-MCCH transmits only one message (i.e., SCPTMConfiguration), which is used to configure the configuration information of SC-PTM. The configuration information of SC-PTM includes a Temporary Mobile Group Identity (TMGI), a session id, a Group RNTI (G-RNTI), Discontinuous Reception (DRX) configuration information and SC-PTM service information of adjacent areas. It should be noted that SC-PTM in R13 does not support a Robust Header Compression (ROHC) function.

Downlink discontinuous reception of SC-PTM is controlled by the following parameters: onDurationTimerSCPTM, drx-InactivityTimerSCPTM, SC-MTCH-SchedulingCycle, and SC-MTCH-SchedulingOffset.

When [(SFN*10)+subframe number] modulo (SC-MTCH-SchedulingCycle)=SC-MTCH-SchedulingOffset, the timer onDurationTimerSCPTM is started.

When the downlink PDCCH scheduling has been received, the timer drx-InactivityTimerSCPTM is started.

The downlink SC-PTM service is received only when the timer onDurationTimerSCPTM or drx-InactivityTimerSCPTM is running.

SC-PTM service continuity adopts the concept of MBMS service continuity based on SIB15, that is, a manner of “SIB15+MBMSInterestIndication”. The service continuity of an idle terminal device is based on a concept of frequency priority.

In the technical solution of the embodiments of the present disclosure, a new SIB (called a first SIB) is defined, the first SIB includes configuration information of the first MCCH, and herein the first MCCH is a control channel of the MBMS service. In other words, the first SIB is used for configuring the configuration information of the control channel of an NR MBMS. Optionally, the control channel of the NR MBMS may also be called an NR MCCH (i.e. the first MCCH).

Further, the first MCCH is used for carrying the first signaling, and the embodiments of the present disclosure do not limit the name of the first signaling, for example, the first signaling is signaling A, and the first signaling includes configuration information of at least one first MTCH, where the first MTCH is a service channel of MBMS service (also called a data channel or a transport channel), and the first MTCH is used for transmitting MBMS service data (such as service data of the NR MBMS). In other words, the first MCCH is used to configure the configuration information of the service channel of the NR MBMS. Optionally, the service channel of the NR MBMS may also be referred to as an NR MTCH (i.e. the first MTCH).

Specifically, the first signaling is used for configuring the service channel of the NR MBMS, the service information corresponding to the service channel and the scheduling information corresponding to the service channel. Further, optionally, the service information corresponding to the service channel, such as TMGI, session id and other identification information for identifying the service. Scheduling information corresponding to the service channel, such as RNTI used when MBMS service data corresponding to the service channel is scheduled, such as G-RNTI, DRX configuration information, etc.

It should be noted that the transmission of the first MCCH and the first MTCH is based on PDCCH scheduling. The RNTI used by the PDCCH for scheduling the first MCCH uses a unique identification of the whole network, that is, the identification is a fixed value. The RNTI used by the PDCCH for scheduling the first MTCH is configured by the first MCCH.

It should be noted that the embodiments of the present disclosure does not limit the naming of the first SIB, the first MCCH and the first MTCH. For convenience of description, the first SIB may also be abbreviated as SIB, the first MCCH may also be abbreviated as MCCH, and the first MTCH may also be abbreviated as MTCH. The PDCCH for scheduling the MCCH (i.e., MCCH PDCCH) and the notification PDCCH are configured by the SIB, where the PDSCH for transmitting the MCCH (i.e., MCCH PDSCH) is scheduled by DCI carried by the MCCH PDCCH. Further, M PDCCHs (i.e., MTCH 1 PDCCH, MTCH 2 PDCCH, . . . , MTCH M PDCCH) for scheduling MTCH are configured by MCCH, where DCI carried by MTCH n PDCCH schedules PDSCH for transmitting MTCH n (i.e., MTCH n PDSCH), and n is an integer greater than or equal to 1 and less than or equal to M. the MCCH and MTCH are mapped onto DL-SCH, and further, the DL-SCH is mapped onto PDSCH, where the MCCH and MTCH are logical channels, the DL-SCH is a transport channel, and the PDSCH is a physical channel.

It should be noted that although the above solution is illustrated by MBMS as an example, the description of “MBMS” may also be replaced by “MBS”. Embodiments of the present disclosure are illustrated with MBS as an example, and the description of “MBS” may also be replaced by “MBMS”.

In the NR system, it needs to support service requirements of multicast type and broadcast type in many scenarios, such as an Internet of Vehicles and an Industrial Internet, etc. Therefore, it is necessary to introduce an MBS of multicast type and an MBS of broadcast type into NR. It should be noted that the MBS of multicast type refers to an MBS transmitted in a multicast manner. The MBS of broadcast type refers to an MBS transmitted in a broadcast manner.

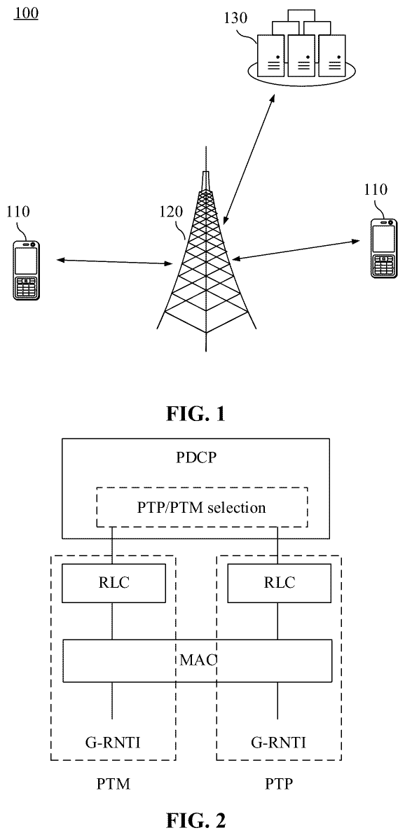

In the NR system, for the MBS of multicast type, the MBS is sent to all terminal devices in a certain group. The terminal devices in an RRC connected state receive the MBS of multicast type, while the terminal device may receive MBS data of multicast type in a Point-To-Multipoint (PTM) manner or a Point-To-Point (PTP) manner. Referring to FIG. 2, the MBS data in the PTM manner scrambles the corresponding scheduling information through G-RNTI configured on the network side, and the MBS data in the PTP manner scrambles the corresponding scheduling information through C-RNTI.

For the MBS of multicast type, after receiving an MBS from a core network from a shared tunnel, the base station may send the MBS to all terminal devices in a group through the air interface. Here, the base station may send the MBS to all terminal devices in a group through a PTP manner and/or a PTM manner. For example, a group includes terminal device 1, terminal device 2 and terminal device 3. The base station may send the MBS to the terminal device 1, the terminal device 2 and the terminal device 3 through the PTP manner. Optionally, the base station may send the MBS to the terminal device 1 through the PTP manner and send the MBS to the terminal device 2 and the terminal device 3 through the PTM manner. Optionally, the base station may send MBS to the terminal device 1, the terminal device 2 and the terminal device 3 through the PTM manner. A shared GTP tunnel is used between the core network and the base station to transmit the MBS, that is, both MBS of the PTM manner and MBS of the PTP manner share this GTP tunnel. The base station sends MBS data to UE1 and UE2 according to the PTM manner, and sends MBS data to UE3 according to the PTP manner.

For the MBS of multicast type (abbreviated as multicast MBS), a DRX mechanism is introduced to save energy for a terminal device. For convenience, DRX used for multicast MBS reception is called MBS DRX, and DRX used for traditional unicast service reception is called unicast DRX. MBS DRX and unicast DRX are independent of each other. As an example, parameters related to MBS DRX may refer to Table 1 below, and the network side may configure the parameters shown in Table 1 through an RRC signaling, so as to control the operation of MBS DRX through these parameters. It should be noted that MBS DRX is configured per G-RNTI or per G-CS-RNTI. For the terminal device, the DRX activation time includes the running time of the following timers: drx-onDurationTimerPTM, drx-InactivityTimerPTM, and drx-RetransmissionTimer-DL-PTM.

TABLE 1
drx-onDurationTimerPTM: the duration at the beginning of a DRX cycle;
drx-SlotOffsetPTM: the delay before starting the drx-onDurationTimerPTM;
drx-InactivityTimerPTM: the duration after the PDCCH occasion in which a PDCCH indicates
a new DL multicast transmission for the MAC entity;
drx-LongCycleStartOffsetPTM: the long DRX cycle drx-LongCycle-PTM and
drx-StartOffset-PTM which defines the subframe where the long DRX cycle starts;
drx-RetransmissionTimer-DL-PTM (per DL HARQ process for multicast MBS): the maximum
duration until a DL multicast retransmission is received;
drx-HARQ-RTT-Timer-DL-PTM (per DL HARQ process for multicast MBS): the minimum
duration before a DL multicast assignment for HARQ retransmission is expected by the MAC
entity;

On the one hand, during the transmission of multicast MBS, there is a scenario where PTP is used for PTM retransmission, that is, a Transport Block (TB) of MBS is transmitted initially in the PTM manner (that is, corresponding scheduling information is scrambled by G-RNTI), and if the reception fails, retransmission is carried out in the PTP manner (that is, corresponding scheduling information is scrambled by C-RNTI). Since MBS DRX and unicast DRX are independent of each other, how to use MBS DRX is an unclear problem.

On the other hand, during the transmission of multicast MBS, there is a Hybrid Automatic Repeat reQuest (HARQ) feedback for transmission of PTM manner, and types of HARQ feedback include HARQ feedback based on negative acknowledgment (NACK) only and HARQ feedback based on acknowledgement (ACK)/NACK. In this case, how to use MBS DRX is an unclear problem.

Since unicast DRX is oriented to one terminal device, while MBS DRX is oriented to multiple terminal devices, MBS DRX and unicast DRX are necessarily different. How to design the running mechanism of MBS DRX to ensure that multiple terminal devices do not miss any scheduling data (i.e., do not lose packets) in the process of receiving multicast MBS is a problem that needs to be clarified. In view of this, the following technical solution of the embodiments in the present disclosure is proposed.

In order to facilitate understanding of the technical solution of the embodiments of the present disclosure, the technical solution of the present disclosure will be described in detail by specific embodiments below. The above related technologies can be combined with the technical solution of the embodiments of the present disclosure arbitrarily as an optional solution, all of which belong to the protection scope of the embodiments of the present disclosure. Embodiments of the present disclosure include at least some of the following.

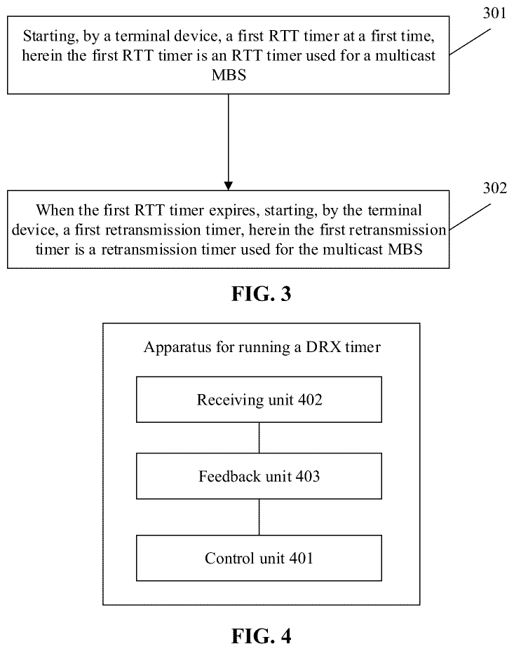

FIG. 3 is a schematic flowchart of a method for running a DRX timer provided by an embodiment of the present disclosure. As illustrated in FIG. 3, the method for running the DRX timer includes the following operations.

At block 301, a terminal device starts a first RTT timer at a first time, herein the first RTT timer is an RTT timer used for a multicast NBS.

At block 302, when the first RTT timer expires, the terminal device starts a first retransmission timer, herein the first retransmission timer is a retransmission timer used for the multicast MBS.

In the embodiments of the present disclosure, the DRX timer for the multicast NBS at least includes a first RTT timer and a first retransmission timer, herein, the first RTT timer is an RTT timer for the multicast NBS, and the first retransmission timer is a retransmission timer for the multicast NBS. As an example, the first RTT timer may be referred to as drx-HARQ-RTT-Timer-DL-PTM, and the first retransmission timer may be referred to as drx-RetransmissionTimer-DL-PTM, and the names of the first RTT timer and the first retransmission timer are not limited herein. In some optional implementations, the DRX timer for the multicast MBS may refer to Table 1 above.

In the embodiments of the present disclosure, the terminal device starts the first RTT timer at the first time, and if the first RTT timer expires, the terminal device starts the first retransmission timer. Here, the DRX activation time of the terminal device includes a time corresponding to running of the first retransmission timer, and the terminal device is in a wake-up state during the DRX activation time, so the terminal device can receive the retransmission data of the multicast NBS during the running of the first retransmission timer.

How the terminal device starts the first RTT timer and the first retransmission timer is described below. It should be noted that “NACK only feedback” described in the following solution may also be called “NACK only based HARQ ACK feedback”, and “ACK/NACK feedback” described in the following solution may also be called “ACK/NACK based HARQ ACK feedback”.

### First Solution

In the embodiments of the present disclosure, the terminal device receives a radio resource control (RRC) dedicated signaling sent by a network device, herein the RRC dedicated signaling is used to configure a feedback mode of the terminal device as a NACK only feedback mode. Further, optionally, the RRC dedicated signaling is further used to configure a common feedback resource corresponding to the NACK only feedback mode.

Here, the NACK only feedback mode means that: if the terminal device receives a TB correctly, it will not give feedback; and if the terminal device receives the TB incorrectly, NACK is fed back. That is to say, for the NACK only feedback mode, the terminal device only feeds back NACK, not ACK.

Here, the common feedback resource may be a common PUCCH resource.

For the NACK only feedback mode, when there is only an ACK of one or more transport blocks (TBs) for the terminal device from an end of a previous feedback to acquisition of a common feedback resource corresponding to a current feedback, the terminal device does not feed back the ACK, and starts the first RTT timer at the first time.

Here, the feature that there is only an ACK of one or more TBs for the terminal device from an end of a previous feedback to acquisition of a common feedback resource corresponding to a current feedback may also be understood as meaning that there is no NACK of the TB for the terminal device from the end of the previous feedback to acquisition of the common feedback resource corresponding to the current feedback.

In some optional embodiments, the first time is determined based on a position of the common feedback resource corresponding to the current feedback. As an example, the first time is a first symbol after an ending position of the common feedback resource corresponding to the current feedback.

In some optional embodiments, the first time is configured by the network device; or the first time is determined based on a reference time configured by the network device. As an example, the first time is the first symbol after the reference time.

In the embodiments of the present disclosure, after starting a first RTT timer at the first time, when the first RTT timer expires, the terminal device starts the first retransmission timer regardless of whether TB decoding in a first hybrid automatic repeat request (HARQ) process succeeds or fails, herein the first RTT timer has an association relationship with the first HARQ process.

### Second Solution

In the embodiments of the present disclosure, the terminal device receives an RRC dedicated signaling sent by a network device, herein the RRC dedicated signaling is used to configure a feedback mode of the terminal device as a NACK only feedback mode. Further, optionally, the RRC dedicated signaling is further used to configure a common feedback resource corresponding to the NACK only feedback mode.

Here, the NACK only feedback mode means that: if the terminal device receives a TB correctly, it will not give feedback; and if the terminal device receives the TB incorrectly, NACK is fed back. That is to say, for the NACK only feedback mode, the terminal device only feeds back NACK, not ACK.

Here, the common feedback resource may be a common PUCCH resource.

For the NACK only feedback mode, when there is only an ACK of one TB for the terminal device from an end of a previous feedback to acquisition of a common feedback resource corresponding to a current feedback, the terminal device feeds back the NACK, and starts the first RTT timer at the first time. In some optional implementations, the terminal device feeding back the NACK may be implemented in the following manners.

First manner: the terminal device uses the common feedback resource to feed back the NACK.

Second manner: the terminal device uses the dedicated feedback resource to feed back the NACK.

In some optional embodiments, the first time is determined based on a position of the common feedback resource corresponding to the current feedback. As an example, the first time is a first symbol after an ending position of the common feedback resource corresponding to the current feedback.

In some optional embodiments, the first time is configured by the network device; or the first time is determined based on a reference time configured by the network device. As an example, the first time is the first symbol after the reference time.

In the embodiments of the present disclosure, after starting a first RTT timer at the first time, when the first RTT timer expires, the terminal device starts the first retransmission timer in a case that TB decoding in a first HARQ process succeeds or fails, herein the first RTT timer has an association relationship with the first HARQ process.

### Third Solution

In the embodiments of the present disclosure, the terminal device receives an RRC dedicated signaling sent by a network device, herein the RRC dedicated signaling is used to configure a feedback mode of the terminal device as a NACK only feedback mode. Further, optionally, the RRC dedicated signaling is further used to configure a common feedback resource corresponding to the NACK only feedback mode.

Here, the NACK only feedback mode means that: if the terminal device receives a TB correctly, it will not give feedback; and if the terminal device receives the TB incorrectly, NACK is fed back. That is to say, for the NACK only feedback mode, the terminal device only feeds back NACK, not ACK.

Here, the common feedback resource may be a common PUCCH resource.

For the NACK only feedback mode, when there are feedbacks of multiple TBs for the terminal device from an end of a previous feedback to acquisition of a common feedback resource corresponding to a current feedback, and a feedback of at least one TB in the feedbacks of the multiple TBs is a NACK, the terminal device feeds back an ACK/NACK of the multiple TBs, and starts the first RTT timer at the first time. In some optional implementations, the terminal device feeding back the NACK may be implemented in the following manners.

Manner A: the terminal device uses the common feedback resource to feed back the ACK/NACK of the multiple TBs.

Manner B: the terminal device uses the dedicated feedback resource to feed back the ACK/NACK of the multiple TBs.

In the above solution, the terminal device feeds back the ACK/NACK of the multiple TBs, which can be understood as the terminal device switches from the NACK only feedback mode to the ACK/NACK feedback mode, and carries out corresponding ACK/NACK feedback for each TB in the multiple TBs.

In some optional embodiments, the first time is determined based on a position of the common feedback resource corresponding to the current feedback. As an example, the first time is a first symbol after an ending position of the common feedback resource corresponding to the current feedback.

In some optional embodiments, the first time is configured by the network device; or the first time is determined based on a reference time configured by the network device. As an example: the first time is the first symbol after the reference time.

In the embodiments of the present disclosure, after starting a first RTT timer at the first time, when the first RTT timer expires, the terminal device starts the first retransmission timer in a case that TB decoding in a first HARQ process succeeds or fails, herein the first RTT timer has an association relationship with the first HARQ process.

### Fourth Solution

In the embodiments of the present disclosure, the terminal device receives an RRC dedicated signaling sent by a network device, herein the RRC dedicated signaling is used to configure a feedback mode of the terminal device as an ACK/NACK feedback mode. Further, optionally, the RRC dedicated signaling is further used to configure a dedicated feedback resource corresponding to the ACK/NACK feedback mode.

Here, the ACK/NACK feedback mode means that: if the terminal device receives a TB correctly, ACK is fed back; and if the terminal device receives TB incorrectly, NACK is fed back. That is to say, for the ACK/NACK feedback mode, the terminal device performs ACK/NACK feedback for each TB, and feeds back ACK if TB is received correctly, and feeds back NACK if TB is received incorrectly.

Here, the dedicated feedback resource may be a dedicated PUCCH resource.

For the ACK/NACK feedback mode, when there is a feedback of at least one TB for the terminal device from an end of a previous feedback to acquisition of a dedicated feedback resource corresponding to a current feedback, the terminal device feeds back an ACK/NACK of the at least one TB, and starts the first RTT timer at the first time.

In some optional embodiments, the first time is determined based on a feedback time of the at least one TB. As an example, the first time is a first symbol after the feedback time of the at least one TB.

In the embodiments of the present disclosure, after starting a first RTT timer at the first time, when the first RTT timer expires, the terminal device starts the first retransmission timer in a case that TB decoding in a first HARQ process succeeds or fails, herein the first RTT timer has an association relationship with the first HARQ process.

The technical solution of the embodiments of the present disclosure is exemplarily illustrated in combination with specific application examples.

### First Application Example

The network configures a feedback mode of G-RNTI associated multicast MBS as the NACK only feedback mode for the terminal device through an RRC dedicated signaling, and configures a common PUCCH resource corresponding to the NACK only feedback mode.

For the NACK only feedback mode, when there is only an ACK of one or more TBs (i.e. no NACK of the TB) for the terminal device from an end of a previous feedback to acquisition of a common feedback resource (i.e. a NACK only resource) corresponding to a current feedback, the terminal device does not feed back ACK (i.e., the terminal device does not feed back anything), and the terminal device starts drx-HARQ-RTT-Timer-DL-PTM (i.e. first RTT timer) associated with the G-RNTI. The drx-HARQ-RTT-Timer-DL-PTM starts at the first symbol after the end of the common PUCCH resource (i.e. the NACK only resource) position. When the drx-HARQ-RTT-Timer-DL-PTM expires, the terminal device starts the drx-RetransmissionTimer-DL-PTM (i.e., the first retransmission timer) after the drx-HARQ-RTT-Timer-DL-PTM timer expires, regardless of whether the TB decoding corresponding to the HARQ process succeeds or fails.

### Second Application Example

The network configures a feedback mode of G-RNTI associated multicast MBS as the NACK only feedback mode for the terminal device through an RRC dedicated signaling, and configures a common PUCCH resource corresponding to the NACK only feedback mode.

For the NACK only feedback mode, when there are feedbacks of multiple TBs for the terminal device from an end of a previous feedback to acquisition of a common feedback resource (i.e. a NACK only resource) corresponding to a current feedback, and a feedback of at least one TB in the feedbacks of the multiple TBs is a NACK, the terminal device feeds back an ACK/NACK of the multiple TBs (that is, the NACK only feedback mode is changed to the ACK/NACK feedback mode), and the terminal device starts drx-HARQ-RTT-Timer-DL-PTM (i.e. first RTT timer) associated with the G-RNTI. The drx-HARQ-RTT-Timer-DL-PTM starts at the first symbol after the end of the common PUCCH resource (i.e. the NACK only resource) position. When the drx-HARQ-RTT-Timer-DL-PTM expires, the terminal device starts the drx-RetransmissionTimer-DL-PTM (i.e., the first retransmission timer) after the drx-HARQ-RTT-Timer-DL-PTM timer expires, regardless of whether the TB decoding corresponding to the HARQ process succeeds or fails.

In the above solution, the terminal device may use a common PUCCH resource to feed back the ACK/NACK of the multiple TBs, or the terminal device may also use a dedicated PUCCH to feed back the ACK/NACK of the multiple TBs. Optionally, if the network side does not configure the common PUCCH resource, the terminal device uses the dedicated PUCCH for feedback, otherwise, the terminal device uses the common PUCCH resource for feedback.

### Third Application Example

The network configures a feedback mode of G-RNTI associated multicast MBS as the NACK only feedback mode for the terminal device through an RRC dedicated signaling, and configures a common PUCCH resource corresponding to the NACK only feedback mode. In addition, the network configures a time or reference time for the terminal device to start drx-HARQ-RTT-Timer-DL-PTM (that is, the first RTT timer).

For the NACK only feedback mode, option 1) when there is only an ACK of one or more TBs (i.e. no NACK of the TB) for the terminal device from an end of a previous feedback to acquisition of a common feedback resource (i.e. a NACK only resource) corresponding to a current feedback, the terminal device does not feed back ACK (that is, the terminal device does not feed back anything), and the terminal device starts drx-HARQ-RTT-Timer-DL-PTM (i.e. first RTT timer) associated with the G-RNTI. The drx-HARQ-RTT-Timer-DL-PTM will start at a time configured by the network or a time determined based on the reference time configured by the network. When the drx-HARQ-RTT-Timer-DL-PTM expires, the terminal device starts the drx-RetransmissionTimer-DL-PTM (i.e., the first retransmission timer) after the drx-HARQ-RTT-Timer-DL-PTM timer expires, regardless of whether the TB decoding corresponding to the HARQ process succeeds or fails.

For the NACK only feedback mode, option 2) when there are feedbacks of multiple TBs for the terminal device from an end of a previous feedback to acquisition of a common feedback resource (i.e. a NACK only resource) corresponding to a current feedback, and a feedback of at least one TB in the feedbacks of the multiple TBs is a NACK, the terminal device feeds back an ACK/NACK of the multiple TBs (that is, the NACK only feedback mode is changed to the ACK/NACK feedback mode), and the terminal device starts drx-HARQ-RTT-Timer-DL-PTM (i.e. first RTT timer) associated with the G-RNTI. The drx-HARQ-RTT-Timer-DL-PTM will start at a time configured by the network or a time determined based on the reference time configured by the network. When the drx-HARQ-RTT-Timer-DL-PTM expires, the terminal device starts the drx-RetransmissionTimer-DL-PTM (i.e., the first retransmission timer) after the drx-HARQ-RTT-Timer-DL-PTM timer expires, regardless of whether the TB decoding corresponding to the HARQ process succeeds or fails.

In the above solution, the terminal device may use a common PUCCH resource to feed back the ACK/NACK of the multiple TBs, or the terminal device may also use a dedicated PUCCH to feed back the ACK/NACK of the multiple TBs. Optionally, if the network side does not configure the common PUCCH resource, the terminal device uses the dedicated PUCCH for feedback, otherwise, the terminal device uses the common PUCCH resource for feedback.

### Fourth Application Example

The network configures a feedback mode of G-RNTI associated multicast MBS as the ACK/NACK feedback mode for the terminal device through an RRC dedicated signaling, and configures a dedicated PUCCH resource corresponding to the ACK/NACK feedback mode.

For the ACK/NACK feedback mode, when there is a feedback of at least one TB for the terminal device from an end of a previous feedback to acquisition of a dedicated feedback resource corresponding to a current feedback, the terminal device feeds back an ACK/NACK of the at least one TB, and starts drx-HARQ-RTT-Timer-DL-PTM at the first symbol after the end of feedback. When the drx-HARQ-RTT-Timer-DL-PTM expires, the terminal device starts the drx-RetransmissionTimer-DL-PTM (i.e., the first retransmission timer) after the drx-HARQ-RTT-Timer-DL-PTM timer expires, regardless of whether the TB decoding corresponding to the HARQ process succeeds or fails.

The technical solution of the embodiments of the present disclosure defines how to start the RTT timer and the retransmission timer, thereby aligning the activation time of multiple terminal devices receiving the multicast MBS to the greatest extent, ensuring that the multiple terminal devices can receive the multicast MBS data, and greatly reducing a packet loss rate of the terminal device in the process for receiving multicast MBS.

Preferred embodiments of the present disclosure have been described in detail with reference to the accompanying drawings, but the present disclosure is not limited to the specific details of the above embodiments. Within the scope of the technical conception of the present disclosure, various simple modifications can be made to the technical solution of the present disclosure, and these simple modifications all belong to the scope of protection of the present disclosure. For example, each of the specific technical features described in the above specific embodiments may be combined in any suitable manner without contradiction, and various possible combinations are not further described in the present disclosure in order to avoid unnecessary repetition. For another example, any combination may be made between the various embodiments of the present disclosure so long as it does not depart from the idea of the present disclosure and is likewise to be regarded as the disclosure of the present disclosure. For another example, on the premise of no conflict, each embodiment described in the present disclosure and/or the technical features in each embodiment can be arbitrarily combined with the related art, and the technical solution obtained after combination should also fall within the scope of protection of the present disclosure.

It should be understood that in various method embodiments of the present disclosure, the size of the sequence number of the above-mentioned processes does not mean the order of execution, and the execution order of each process should be determined by its function and inherent logic, and should not be limited in any way to the implementation process of the embodiments of the present disclosure. Further, in embodiments of the present disclosure, the terms “downlink”, “uplink” and “sidelink” are used to denote a transmission direction of the signal or data, where “downlink” is used to denote the transmission direction of the signal or data as a first direction transmitted from a site to user equipment of the cell, and “uplink” is used to denote the transmission direction of the signal or data as a second direction transmitted from the user equipment of the cell to the site, “sidelink” is used to denote the transmission direction of the signal or data as a first direction transmitted from a user equipment 1 to a user equipment 2. For example, “downlink signal” denotes that the transmission direction of the signal is the first direction. In the present disclosure, the term “and/or” is used to describe an association relationship of associated objects, and represents that there may be three relationships. Specifically, A and/or B may represent the following three situations: i.e., independent existence of A, existence of both A and B and independent existence of B. In addition, the character “/” in the present disclosure generally represents that an “or” relationship is formed between the previous and next associated objects.

FIG. 4 is a schematic diagram of a structural composition of an apparatus for running a DRX timer provided by the embodiment of the present disclosure, and the DRX configuration apparatus is applied to a terminal device. As illustrated in FIG. 4, the apparatus for running the DRX timer includes a control unit 401.

The control unit 401 is configured to start a first round trip time (RTT) timer at a first time, herein the first RTT timer is an RTT timer used for a multicast MBS; and when the first RTT timer expires, start a first retransmission timer, herein the first retransmission timer is a retransmission timer used for the multicast MBS.

In some optional implementations, the apparatus further includes a receiving unit 402. The receiving unit 402 is configured to receive a radio resource control (RRC) dedicated signaling sent by a network device, herein the RRC dedicated signaling is used to configure a feedback mode of the terminal device as a negative acknowledgment (NACK) only feedback mode.

In some optional implementations, the RRC dedicated signaling is further used to configure a common feedback resource corresponding to the NACK only feedback mode.

In some optional implementations, the apparatus further includes a feedback unit 403. The feedback unit 403 is configured to not feed back the ACK when there is only an acknowledgement (ACK) of one or more transport blocks (TBs) for the terminal device from an end of a previous feedback to acquisition of a common feedback resource corresponding to a current feedback, and the control unit 401 is configured to start the first RTT timer at the first time.

In some optional implementations, the apparatus further includes a feedback unit 403. The feedback unit 403 is configured to feed back the ACK when there is only a NACK of one TB for the terminal device from an end of a previous feedback to acquisition of a common feedback resource corresponding to a current feedback, and the control unit 401 is configured to start the first RTT timer at the first time.

In some optional implementations, the feedback unit 403 is configured to feed back the NACK by using the common feedback resource; or feed back the NACK by using a dedicated feedback resource.

In some optional implementations, the apparatus further includes a feedback unit 403. The feedback unit 403 is configured to feed back an ACK/NACK of the multiple TBs when there are feedbacks of multiple TBs for the terminal device from an end of a previous feedback to acquisition of a common feedback resource corresponding to a current feedback, and a feedback of at least one TB in the feedbacks of the multiple TBs is a NACK, and the control unit 401 is configured to start the first RTT timer at the first time.

In some optional implementations, the feedback unit 403 is configured to feed back the ACK/NACK of the multiple TBs by using the common feedback resource; or feed back the ACK/NACK of the multiple TBs by using a dedicated feedback resource.

In some optional implementations, the first time is determined based on a position of a common feedback resource corresponding to a current feedback.

In some optional implementations, the first time is a first symbol after an ending position of the common feedback resource corresponding to the current feedback.

In some optional implementations, the first time is configured by the network device; or the first time is determined based on a reference time configured by the network device.

In some optional implementations, the apparatus further includes a receiving unit 402. The receiving unit 402 is configured to receive a radio resource control (RRC) dedicated signaling sent by a network device, herein the RRC dedicated signaling is used to configure a feedback mode of the terminal device as an ACK/NACK feedback mode.

In some optional implementations, the RRC dedicated signaling is further used to configure a dedicated feedback resource corresponding to the ACK/NACK feedback mode.

In some optional implementations, the apparatus further includes a feedback unit 403. The feedback unit 403 is configured to feed back an ACK/NACK of the at least one TB when there is a feedback of at least one TB for the terminal device from an end of a previous feedback to acquisition of a dedicated feedback resource corresponding to a current feedback, and the control unit 401 is configured to start the first RTT timer at the first time.

In some optional implementations, the first time is determined based on a feedback time of the at least one TB.

In some optional implementations, the first time is a first symbol after the feedback time of the at least one TB.

In some optional implementations, the control unit 401 is configured to: when the first RTT timer expires, start the first retransmission timer in a case that TB decoding in a first hybrid automatic repeat request (HARQ) process succeeds or fails, herein the first RTT timer has an association relationship with the first HARQ process.

In some optional implementations, the terminal device is capable of receiving retransmission data of the multicast MBS during running the first retransmission timer.

It will be understood by those skilled in the art that the above description of the apparatus for running a DRX timer of the embodiment of the present disclosure may be understood with reference to the description of the method for running a DRX timer of the embodiment of the present disclosure.

FIG. 5 is a schematic structural diagram of a communication device 500 provided by an embodiment of the present disclosure. The communication device may be a terminal device. A communication device 500 illustrated in FIG. 5 includes a processor 510 that may call and execute a computer program from a memory to implement the method in an embodiment of the present disclosure.

Optionally, as illustrated in FIG. 5, the communication device 500 may also include a memory 520. The processor 510 may call and execute a computer program from memory 520 to implement the method in the embodiments of the present disclosure.

The memory 520 may be a separate device independent of the processor 510 or may be integrated in the processor 510.

Optionally, as illustrated in FIG. 5, the communication device 500 may also include a transceiver 530. The processor 510 may control the transceiver 530 to communicate with other devices, and in particular may send information or data to other devices, or receive information or data sent by other devices.

The transceiver 530 may include a transmitter and a receiver. The transceiver 530 may further include antennas. The number of antennas may be one or more.

The communication device 500 specifically may be a terminal device of the embodiments of the present disclosure, and the communication device 500 may implement corresponding processes implemented by the terminal device in the respective methods of the embodiment of the present disclosure, which will not be repeated here for the sake of brevity.

FIG. 6 is a schematic structural diagram of a chip according to an embodiment of the present disclosure. A chip 600 illustrated in FIG. 6 includes a processor 610 that may call and execute a computer program from memory to implement the method in the embodiments of the present disclosure.

Optionally, as illustrated in FIG. 6, the chip 600 may also include a memory 620. The processor 610 may call and execute a computer program from the memory 620 to implement the method in the embodiments of the present disclosure.

The memory 620 may be a separate device independent of the processor 610 or may be integrated in the processor 610.

Optionally, the chip 600 may also include an input interface 630. The processor 610 may control the input interface 630 to communicate with other devices or chips, and in particular obtain information or data sent by other devices or chips.

Optionally, the chip 600 may also include an output interface 640. The processor 610 may control the output interface 640 to communicate with other devices or chips, and in particular output information or data to other devices or chips.

The chip may applied to be a terminal device of the embodiments of the present disclosure, and the chip may implement corresponding processes implemented by the terminal device in various methods of the embodiments of the present disclosure, which will not be repeated here for the sake of brevity.

It should be understood that the chip referred to in the embodiments of the present disclosure may also be referred to as a system-level chip, a system chip, a chip system or a system-on-chip or the like.

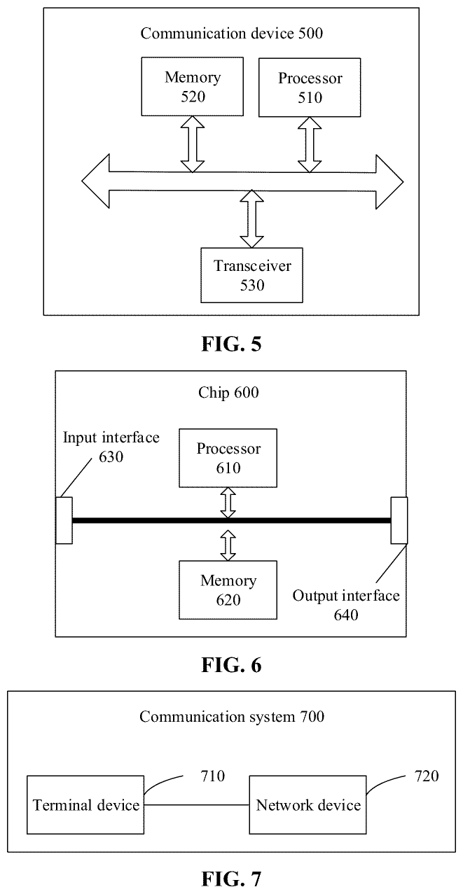

FIG. 7 is a schematic block diagram of a communication system 700 provided by an embodiment of the present disclosure. As illustrated in FIG. 7, the communication system 700 includes a terminal device 710 and a network device 720.

The terminal device 710 may be configured to implement corresponding functions implemented by the terminal device in the above method, and the network device 720 may be configured to implement corresponding functions implemented by the network device in the above method, which will not be repeated here for the sake of brevity.

It should be understood that the processor may be an integrated circuit chip having signal processing capability. In implementation, the operations of the above method embodiments may be accomplished by integrated logic circuitry of hardware in processor or instructions in the form of software. The processor may be a general purpose processor, a digital signal processor (DSP), an application specific integrated circuit (ASIC), a field programmable gate array (FPGA) or other programmable logic devices, discrete gates or transistor logic devices, or discrete hardware components. The processor may implement or execute the methods, operations and logic diagrams disclosed in the embodiments of the present disclosure. The general purpose processor may be a microprocessor or any conventional processor. The operations of the method disclosed in the embodiments of the present disclosure may be directly embodied as being executed by a hardware decoding processor or being executed by the hardware and software modules in a decoding processor. The software modules may be located in a storage medium mature in the art, such as a random access memory, a flash memory, a read-only memory, a programmable read-only memory or an electrically erasable programmable memory, a register, etc. The storage medium is located in the memory, and the processor reads the information in the memory to complete the operations of the aforementioned method in conjunction with its hardware.

It will be appreciated that the memory in the embodiments of the present disclosure may be a volatile memory or a non-volatile memory, or may also include both a volatile memory and a non-volatile memory. The non-volatile memory may be a read-only memory (ROM), a programmable ROM (PROM), an erasable PROM (EPROM), an electrically EPROM (EPROM) or a flash memory. The volatile memory may be a random access memory (RAM), which serves as an external cache. By way of illustration but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), a direct rambus RAM (DR RAM). It should be noted that the memory in the systems and methods described herein is intended to include, but is not limited to, these memories and any other suitable types of memory.

It should be understood that the memory described above is exemplary but not limiting. For example, the memory in the embodiments of the present disclosure may also be a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), a direct rambus RAM (DR RAM), etc. That is, the memory in the embodiments of the present disclosure is intended to include, but is not limited to, these memories and any other suitable types of memory.

In an embodiment of the present disclosure, there is further provided a computer-readable storage medium, configured to store a computer program. The computer readable storage medium may be applied to the terminal device of the embodiments of the present disclosure, and the computer program causes a computer to implement corresponding processes implemented by the terminal device in the methods of the embodiments of the present disclosure, which will not be repeated here for the sake of brevity.

In an embodiment of the present disclosure, there is further provided a computer program product, which includes computer program instructions. The computer program product may be applied to the terminal device of the embodiments of the present disclosure, and the computer program instructions cause a computer to implement corresponding processes implemented by the terminal device in the methods of the embodiments of the present disclosure, which will not be repeated here for the sake of brevity.

In an embodiment of the present disclosure, there is further provided a computer program. The computer program may be applied to the terminal device of the embodiments of the present disclosure, the computer program, when running on a computer, causes the computer to implement corresponding processes implemented by the terminal device in the methods of the embodiments of the present disclosure, which will not be repeated here for the sake of brevity.

Those of ordinary skill in the art may realize that the various example units and algorithm steps described in connection with the embodiments disclosed herein may be implemented in electronic hardware or a combination of computer software and electronic hardware. Whether these functions are performed in hardware or software depends on the specific application and design constraints of the technical solution. Professionals may use different methods for each particular application to implement the described functionality, but such implementation should not be considered beyond the scope of the present disclosure.

Those skilled in the art will clearly appreciate that, for convenience and conciseness of description, the specific operating processes of the above-described systems, apparatuses and units may refer to the corresponding processes in the aforementioned method embodiments and will not be repeated herein.

In several embodiments provided herein, it should be understood that the disclosed systems, apparatuses and methods may be implemented in other manners. For example, the above-described embodiments of the apparatus is only schematic, for example, the division of the units is only a logical function division, and in practice, there may be another division manner, for example, multiple units or components may be combined or integrated into another system, or some features may be ignored or not performed. On the other hand, the coupling or direct coupling or communication connection between each other illustrated or discussed may be indirect coupling or communication connection through some interfaces, devices or units, and may be electrical, mechanical or other form.

The units illustrated as separate elements may or may not be physically separated, and the elements displayed as units may or may not be physical units, i.e. may be located in a place, or may be distributed over multiple network units. Part or all of the units may be selected according to the actual needs to achieve the purpose of the embodiments of the present disclosure.

In addition, each functional unit in each embodiment of the present disclosure may be integrated in one processing unit, each unit may exist physically alone, or two or more units may be integrated in one unit.

When the functions are realized in the form of software functional units and sold or used as an independent product, they may be stored in a computer readable storage medium. Based on such an understanding, the technical solutions according to the disclosure, in essence or the part contributing to the prior art, or part of the technical solutions can be embodied in the form of a software product. The computer software product is stored in a storage medium, and includes several instructions so that a computer device (which may be a personal computer, a server, a network device or the like) implements all or part of the method according to respective embodiments of the disclosure. The aforementioned storage medium includes various media capable of storing a program code such as a USB disk, a mobile hard drive disk, a read-only memory (ROM), a random access memory (RAM), a magnetic disk or an optical disk.

The above is only the specific implementation of the present disclosure, but the scope of protection of the present disclosure is not limited thereto. Any person skilled in the art may easily think of changes or substitutions within the technical scope disclosed in the present disclosure, which should be covered within the protection scope of the present disclosure. Therefore, the scope of protection of the present disclosure shall be subject to the scope of protection of the claims.

1. A method for running a discontinuous reception (DRX) timer, comprising:
starting, by a terminal device, a first round trip time (RTT) timer at a first time, wherein the first RTT timer is an RTT timer used for a multicast multimedia broadcast service (MBS); and
when the first RTT timer expires, starting, by the terminal device, a first retransmission timer, wherein the first retransmission timer is a retransmission timer used for the multicast MBS.

2. The method of claim 1, further comprising:
receiving, by the terminal device, a radio resource control (RRC) dedicated signaling sent by a network device, wherein the RRC dedicated signaling is used to configure a feedback mode of the terminal device as a negative acknowledgment (NACK) only feedback mode.

3. The method of claim 2, wherein the RRC dedicated signaling is further used to configure a common feedback resource corresponding to the NACK only feedback mode.

4. The method of claim 2, wherein starting, by the terminal device, the first RTT timer at the first time comprises:
when there is only a NACK of one TB for the terminal device from an end of a previous feedback to acquisition of a common feedback resource corresponding to a current feedback, feeding back, by the terminal device, the NACK, and starting, by the terminal device, the first RTT timer at the first time.

5. The method of claim 4, wherein feeding back, by the terminal device, the NACK comprises:
feeding back, by the terminal device, the NACK by using the common feedback resource; or
feeding back, by the terminal device, the NACK by using a dedicated feedback resource.

6. The method of claim 2, wherein the first time is determined based on a position of a common feedback resource corresponding to a current feedback.

7. The method of claim 6, wherein the first time is a first symbol after an ending position of the common feedback resource corresponding to the current feedback.

8. The method of claim 1, further comprising:
receiving, by the terminal device, an RRC dedicated signaling sent by a network device, wherein the RRC dedicated signaling is used to configure a feedback mode of the terminal device as an ACK/NACK feedback mode.

9. The method of claim 8, wherein the RRC dedicated signaling is further used to configure a dedicated feedback resource corresponding to the ACK/NACK feedback mode.

10. A terminal device, comprising: a processor and a memory storing a computer program, wherein the processor is configured to call and execute the computer program stored in the memory to cause the terminal device to perform the method of:
starting a first round trip time (RTT) timer at a first time, wherein the first RTT timer is an RTT timer used for a multicast multimedia broadcast service (MBS); and
when the first RTT timer expires, starting a first retransmission timer, wherein the first retransmission timer is a retransmission timer used for the multicast MBS.

11. The terminal device of claim 10, wherein the terminal device is further configured to:
receive a radio resource control (RRC) dedicated signaling sent by a network device, wherein the RRC dedicated signaling is used to configure a feedback mode of the terminal device as a negative acknowledgment (NACK) only feedback mode.

12. The terminal device of claim 11, wherein the RRC dedicated signaling is further used to configure a common feedback resource corresponding to the NACK only feedback mode.

13. The terminal device of claim 11, wherein when starting the first RTT timer at the first time, the terminal device is configured to:
when there is only a NACK of one TB for the terminal device from an end of a previous feedback to acquisition of a common feedback resource corresponding to a current feedback, feed back the NACK, and start the first RTT timer at the first time.

14. The terminal device of claim 13, wherein when feeding back the NACK, the terminal device is configured to:
feeding back the NACK by using the common feedback resource; or
feeding back the NACK by using a dedicated feedback resource.

15. The terminal device of claim 11, wherein the first time is determined based on a position of a common feedback resource corresponding to a current feedback.

16. The terminal device of claim 15, wherein the first time is a first symbol after an ending position of the common feedback resource corresponding to the current feedback.

17. The terminal device of claim 10, wherein the terminal device is further configured to:
receive an RRC dedicated signaling sent by a network device, wherein the RRC dedicated signaling is used to configure a feedback mode of the terminal device as an ACK/NACK feedback mode.

18. The terminal device of claim 17, wherein the RRC dedicated signaling is further used to configure a dedicated feedback resource corresponding to the ACK/NACK feedback mode.

19. A chip, comprising: a processor, configured to call and execute a computer program in a memory to cause a terminal device equipped with the chip to perform the method of:
starting a first round trip time (RTT) timer at a first time, wherein the first RTT timer is an RTT timer used for a multicast multimedia broadcast service (NMBS); and
when the first RTT timer expires, starting a first retransmission timer, wherein the first retransmission timer is a retransmission timer used for the multicast MBS.

20. The chip of claim 19, wherein the chip is further configured to cause the terminal device to:
receive a radio resource control (RRC) dedicated signaling sent by a network device, wherein the RRC dedicated signaling is used to configure a feedback mode of the terminal device as a negative acknowledgment (NACK) only feedback mode.
